SEQUENCE LISTING (8 sequences)

SEQ ID NO: 1 - DNA, 20 bp, synthetic construct
  source 1..20: mol_type = other DNA
cgtcgagtcttgcttctcgt

SEQ ID NO: 2 - DNA, 20 bp, synthetic construct
  source 1..20: mol_type = other DNA
agctgagctctgtctgcttg

SEQ ID NO: 3 - DNA, 20 bp, synthetic construct
  source 1..20: mol_type = other DNA
agtgggaagaacagcttcgg

SEQ ID NO: 4 - DNA, 20 bp, synthetic construct
  source 1..20: mol_type = other DNA
cttctccgtgcttcgaggtt

SEQ ID NO: 5 - DNA, 19 bp, synthetic construct
  source 1..19: mol_type = other DNA
aagtgattgcacgggaagc

SEQ ID NO: 6 - DNA, 20 bp, synthetic construct
  source 1..20: mol_type = other DNA
ctgaagcagtccactgacca

SEQ ID NO: 7 - DNA, 21 bp, synthetic construct
  source 1..21: mol_type = other DNA
aggaggattatggagttgctg

SEQ ID NO: 8 - DNA, 25 bp, synthetic construct
  source 1..25: mol_type = other DNA
gcaacttcctcttaactttaccaaa

(19) United States
(12) Patent Application Publication
(10) Pub. No.: US 2024/0306645 A1
(43) Pub. Date: Sep. 19, 2024

(54) USE OF AN ACID WHEY TO STIMULATE THE GERMINATION OF A PLANT POLLEN GRAIN

(71) Applicants: AGRO INNOVATION INTERNATIONAL, Saint-Malo (FR); UNIVERSITE DE ROUEN-NORMANDIE, Mont-Saint-Aignan Cedex (FR)

(72) Inventors: Emmanuel Eric NGUEMA-ONA, Saint-Malo (FR); Florence CRUZ, Saint-Malo (FR); Frank JAMOIS, Saint-Malo (FR); Sylvain PLUCHON, Saint-Malo (FR); Jean-Claude MOLLET, Mont-Saint-Aignan Cedex (FR); Arnaud LEHNER, Mont-Saint-Aignan Cedex (FR)

(21) Appl. No.: 18/681,308

(22) PCT Filed: Aug. 5, 2022
(86) PCT No.: PCT/FR2022/051560

§ 371 Date: Feb. 5, 2024

(30) Foreign Application Priority Data
Aug. 6, 2021 (FR) 2108546

(51) Int. Cl. A01N 63/10; A01P 21/00

(52) U.S. Cl. CPC A01N 63/10; A01P 21/00

(57) ABSTRACT

The invention relates to the use of an acid whey to stimulate the germination of a plant pollen grain and/or to stimulate the elongation of the pollen tube of said pollen grain. According to another aspect, the invention relates to a method for stimulating the germination of a plant pollen grain and/or for stimulating the elongation of the pollen tube of said pollen grain, in which an acid whey is applied to the plant in an amount sufficient to stimulate the germination of the pollen grain and/or to stimulate the elongation of the pollen tube of said pollen grain. According to a final aspect, the invention relates to a composition comprising (i) an acid whey and (ii) a brown seaweed extract.

### CROSS-REFERENCE TO RELATED APPLICATIONS

This application is a national stage application of PCT/FR2022/051560 filed 5 Aug. 2022, which claims priority to French Patent Application No. 2108546 filed 6 Aug. 2021, the entire disclosures of each application are herein incorporated by reference.

### SEQUENCE LISTING

The instant application contains a Sequence Listing which has been submitted electronically in XML format and is hereby incorporated by reference in its entirety. Said XML copy, created on 24 Jan. 2024, is named Sequence Listing 0177_0207.xml and is 8,019 bytes in size.

### Technical field

The intervention is applicable in the field of ecological agriculture and agriculture and concerns, in particular, stimulation of the germination of a plant pollen grain and/or the elongation of the pollen tube of said pollen grain.

### Prior art

The sexual reproduction of a plant is a major process in flowering plants, which leads to the formation of seeds or fruits. This sexual reproduction is characterised by the meeting of the male gametes of a plant (present in the pollen grain) and female gametes of a plant (ovules). It is followed by a plurality of consecutive biological processes, such as fruit setting, fruit/seed growth which is characterised by cell division and expansion events, and then by ripening of the seed and/or fruit.

The first step of sexual reproduction, which is already key, is the landing of a pollen grain on the pistil of a plant. The pollen grain or male gamete is generated by the anthers located at the ends of the stamens of the plants. This pollen grain will be transported by the wind or by pollinating insects to the end of the pistil of a plant, namely on the stigma. The female gamete of the plant being located at the base of the pistil, the pollen grain will germinate on the stigma, form a pollen tube which will engage in the pistil and continue there by elongating to the level of the female gamete, also called ovule. This process results in the meeting of the pollen grain and the ovule, enabling fertilisation or sexual reproduction of the plant

The germination of the pollen grain and the growth of the pollen tube correspond to the progamic phase. In flowering plants, this phase takes place relatively quickly (6 to 24 hours on average; some flowering plant species can have a longer progamic phase). The germination of the pollen grain (hydration of the grain following landing on the end of a stigma, the emergence of the pollen tube) can take place in half an hour to several hours. The elongation of the pollen tube which follows is characterised by a polarised growth, by a massive secretion of cell wall materials, for example pectins, and by the synthesis of callose plugs at their walls.

The rapidity of this progamic phase confers an undeniable evolutionary advantage in terms of the success of sexual reproduction. More specifically, the slower the progamic phase, the greater the risk that the pollen grain will never reach the ovule (risk of abortion), in particular due to environmental factors. Thus, when germination of the pollen grain does not give rise to fertilisation, this leads to a reduction in the amount of seeds and fruits produced. The steps of germination of the pollen grain and elongation of the pollen tube are therefore critical steps in the sexual reproduction of flowering plants, the success of these two steps is indispensable for subsequently ensuring the formation of seeds and fruits.

In addition, studies have shown that sexual reproduction of plants is impacted by climate change and, in particular, by variations in temperature [1]. However, in the coming years, the majority of agricultural regions could be subject to significant environmental fluctuations, with large variations in temperature [2]. It has also been demonstrated that the thermal stress induced by cold or hot temperatures has several major effects on the reproductive tissues, particularly at the time of flowering, causing (i) abnormal formation of parental organs, (ii) asynchronous maturation of the male and female gametes, (iii) reduction in the receptiveness of the stigma to pollens, (iv) reduction in the viability and germination of pollen grains, and (v) reduction in the growth of the pollen tube [3][4][5].

Faced with these changes, it is important to find agronomic solutions which enable the capacity of plants to ensure sexual reproduction to be improved, in order to guarantee the production of seeds and fruits.

One of the solutions for promoting germination of a pollen grain is to select new species, which are, for example, tolerant to thermal stresses induced by cold or by heat and which can thus carry out the steps of sexual reproduction, whatever the external temperature. This has been achieved, in particular, for rice [6], tomatoes [7], chickpeas [8], haricot beans [9] or peanuts [10].

Another possibility is to apply compounds on the pollen grains in order to stimulate sexual reproduction of the plants, for example by stimulating germination of the pollen grains and by promoting the growth of the pollen tube. For example, it has been demonstrated that the use of 24-epibrassinolide (a type of brassinosteroid, a natural plant hormone) or melatonin on tomato pollen grains promotes germination of the pollen grains and the growth of their pollen tube.

There is therefore a need to find solutions for guaranteeing the sexual reproduction of plants, and in particular the germination of pollen grains. It is in this context that the invention is located, which responds to a need for novel technical solutions for stimulating germination of a plant pollen grain and/or for stimulating elongation of the pollen tube of said pollen grain.

### SUMMARY OF THE INVENTION

It in this context that the applicant has determined, and this constitutes the basis of the present invention, that acid whey could stimulate the germination of a plant pollen grain and/or stimulate the elongation of the pollen tube of said pollen grain.

According to a first aspect, the invention relates to the use of an acid whey in liquid form for stimulating germination of a plant pollen grain and/or for stimulating elongation of the pollen tube of said pollen grain.

According to a second aspect, the invention relates to a method for stimulating germination of a plant pollen grain and/or for stimulating elongation of the pollen tube of said pollen grain, in which an acid whey in liquid form is applied to the plant in an amount sufficient to stimulate germination of the pollen grain and/or to stimulate elongation of the pollen tube of said pollen grain.

According to a third aspect, the invention relates to a composition comprising (i) an acid whey and (ii) a brown seaweed extract.

### DETAILED DESCRIPTION OF THE INVENTION

### Definitions

The term “acid whey” designates the product resulting from the coagulation of milk by acidification (also called “sour whey”). Acid whey can be obtained by a method including the following steps: a step of coagulation of the milk by acidification, followed by a step of separating the following two by-products (i) curd and (ii) acid whey (solid-liquid separation), optionally followed by a step of microfiltration and/or concentration of the acid whey. The step of coagulating the milk can be carried out by the action enzymes (such as the addition of rennet). The acidification can be obtained by means of lactic acid bacteria or by the addition of a chemical additive, such as chymosin, cyprosin and/or cardosin. The acidification is preferably obtained by means of lactic acid bacteria. FIG. 1 shows a diagram of the by-products obtained from milk, including whey. In the context of the present invention, acid whey can be obtained from any milk, preferably from cow's milk, goat's milk and/or sheep's milk, more preferably from cow's milk. The acid whey preferably has a pH ranging from 3.5 to 5, more preferably from 4 to 5, for example approximately 4.5. The acid whey can consist of more than 90% water, approximately 5% lactose, less than 1% proteins (such as lactoglobulins, albumins, lactoferrins, caseinomacropeptides), less than 1% soluble mineral salts, less than 1% lactic acid and less than 0.1% fat. The preparation of an acid whey can comprise a drying step, in order to obtain an acid whey in powder form. The acid whey in powder form can then be mixed with a solvent, for example water before use. In the context of the invention, an acid whey is in liquid form, which enables it to be easily applied on a plant. In general, acid whey is marketed in powder form. Thus, acid whey in dry form can be diluted in a solvent, for example water, before being applied on a plant.

In the context of the invention, the expression “stimulating the germination of a plant pollen grain” shall mean the fact of accelerating the emergence of a pollen tube from a pollen grain.

In the context of the invention, an “amount sufficient” for stimulating the germination of a plant pollen grain corresponds to an amount enabling the speed and/or frequency of germination of a plant pollen grain to be increased by at least 5%, advantageously by at least 10%, at least 15%, at least 20%, at least 25%, at least 30%, at least 40%, at least 50%, compared with the germination of an untreated pollen grain. The frequency of germination corresponds to the number of pollen grains of a plant having germinated, compared with total number of pollen grains present/countable of said plant, over a given period of time. The measurement of the speed and/or frequency of germination of a pollen grain can be visualised using a binocular loupe or a microscope. A method for observing and quantifying the speed and frequency of germination of pollen grains which is implemented in the context of the present invention is detailed in Example 3.

In the context of the invention, an “amount sufficient” for stimulating the elongation of the pollen tube of a plant pollen grain corresponds to an amount permitting the speed of elongation and/or the density of the pollen tube of a pollen grain to be increased by at least 5%, advantageously by at least 10%, at least 15%, at least 20%, at least 25%, at least 30%, at least 40%, at least 50% compared with a pollen tube of an untreated pollen grain. In addition, an amount sufficient for stimulating the elongation of the pollen tube of a plant pollen grain can be manifest by an increase in the expression of the genes involved in the elongation of the pollen tube of pollen grain of a plant, in particular the genes coding for callose synthase enzymes, called “CalS”, and callose synthase-like enzymes, called “CalS like”, through an increase in the number of callose plugs of the pollen tube and/or by an increase in the activity of the enzyme pectin methylesterase, compared with a pollen tube of an untreated pollen grain. The presence and activity of callose synthase and pectin methylesterases in a pollen tube can be used as a marker of the elongation of a pollen tube. The length of the pollen tube can be determined by measuring the size of the pollen tube in μm, for example using a binocular loupe or a microscope. A method for measuring the elongation of the pollen tube which can be implemented in the context of the present invention is detailed in Example 3. A method for measuring the expression of the genes involved in the elongation of the pollen tube of a pollen grain of a plant, which can be implemented in the context of the present invention, is detailed in Example 3 and can be carried out using a PCR. The measurement of the number of callose plugs of the pollen tube can be carried out by microscopic observation using a staining, for example with aniline blue, of the pollen tube. A method for measuring the number of callose plugs of the pollen tube is detailed in Example 3.

The term “brown seaweed extract” designates the product resulting from the extraction of the content of the cells of a brown seaweed. The brown seaweed extract can be obtained by a method including the following steps: mixing fresh or dried brown seaweed, preferably ground, with water, extraction (solid-liquid separation) and optionally fractionation and/or concentration. The brown seaweed can be easily harvested using conventional methods described in the literature. Dry brown seaweed generally contains less than 5% water, preferably less than 3% water, by mass compared with the total mass of seaweed. The brown seaweed extract is advantageously obtained by extraction with an aqueous solvent or an organic solvent, for example with an aqueous solvent. The brown seaweed extract can be in dry form, for example in powder form, or in liquid form. Thus, the water of the brown seaweed extract can be removed in order to obtain a brown seaweed extract that is more or less dry or liquid, for example containing at least 1% dry matter compared with the total mass of the brown seaweed extract, for example at least 10% dry matter by mass compared with the total mass of the brown seaweed extract, for example at least 20% dry matter, at least 30% dry matter, at least 40% dry matter, at least 50% dry matter, at least 60% dry matter, at least 70% dry matter, at least 80% dry matter, at least 90% dry matter, at least 95% dry matter, preferably between 1 and 15% dry matter, for example between 3.5 and 5% dry matter. The extract can optionally be ultra-filtered in order to obtain a fraction having improved activity compared with brown seaweed extract that is not ultra-filtered. In the context of the invention, the brown seaweed extract is in liquid form in order to be able to be easily applied on a plant. Thus, the brown seaweed extract in dry form can be diluted in a solvent, for example water, before being applied on a plant. A brown seaweed extract can be obtained by implementing the method described in Example 1. The brown seaweed extract is preferably chosen from an extract of Ascophyllum nodosum, an extract of Fucus serratus, an extract of Fucus vesiculosus, an extract of Laminaria hyperborea, an extract of Laminaria saccharina, an extract of Laminaria digitata, an extract of Laminaria japonica, an extract of Ecklonia maxima, an extract of Macrocystis pyrifera , an extract of Himanthalia elongata or an extract of Sargassum spp, more preferably an extract of Ascophyllum nodosum.

The term “sucrose” corresponds to a sugar compound called α-D-glucopyranosyl-(1→2)-β-D-fructofuranoside (UICPA name). Sucrose has, in particular, the following CAS number: 57-50-1. Sucrose can, for example, be extracted from plants such as sugar cane or sugar beet. Sucrose can be in dried form, for example in the form of white or brown sugar, or in liquid form, for example in the form of a syrup. In the context of the invention, the sucrose is in liquid form in order to be able to easily apply said extract on a plant. Thus, sucrose in dry form can be diluted in a solvent, for example water, before being applied on a plant.

The term “fertilising product” designates a substance, or a mixture of substances, of natural or synthetic origin, used in agriculture, horticulture and sylviculture, for improving soils, in particular their structure, and for fertilising cultivated plants. Fertilising products comprise fertilisers and soil amendments.

The term “fertiliser” designates fertilising substances, the main function of which is to apply elements to plants that are directly useful for their nutrition (major fertilising elements, secondary fertilising elements and trace elements).

### Use and Method According to the Invention

The present invention give rise to surprising advantages determined by the inventors, of the effect of an acid whey on the germination of a plant pollen grain and/or the elongation of the pollen tube of said pollen grain.

The invention relates, more specifically, to the use of an acid whey in liquid form for stimulating germination of a plant pollen grain and/or for stimulating elongation of the pollen tube of said pollen grain.

The invention also relates to a method for stimulating germination of a plant pollen grain and/or for stimulating elongation of the pollen tube of said pollen grain, in which an acid whey in liquid form is applied to the plant in an amount sufficient for stimulating the germination of the pollen grain and/or for stimulating the elongation of the pollen tube of said pollen grain.

Preferably, the acid whey stimulates germination of a plant pollen grain and elongation of the pollen tube of said pollen grain. In particular, the acid whey can increase the speed of elongation of the pollen tube by at least 5%, advantageously by at least 10%, at least 15%, at least 20%, at least 25%, at least 30%, at least 40%, at least 50% compared with a pollen grain that is not treated with acid whey.

In a particular embodiment, acid whey is applied to the plant at an external temperature ranging from 5 to 25° C., preferably 8 to 22° C., for example 8° C., 13° C. or 22° C. Advantageously, when the acid whey is applied at an external temperature which induces a thermal stress in the plant, the acid whey can accelerate the germination of a plant pollen grain and the elongation of the pollen tube of said pollen grain. This will, in particular, improve crop yields and increase the number of seeds and fruits of the plant, when the plant is subjected to an external temperature which could cause damage to the germination process.

In a particular embodiment, the plant is in a condition of thermal stress. In particular, the plant is subject to a thermal stress. A temperature introducing a thermal stress depends on the species of plant considered. For example, a thermal stress can be induced by a temperature ranging from 5 to 20° C., for example 7 to 18° C., for example 8 to 13° C. For example, for stone fruit trees, a thermal stress can be induced by a temperature ranging from 7 to 16° C. According to another example, for pome fruit trees, a thermal stress can be induced by a temperature ranging from 7 to 16° C.

The application of acid whey in liquid form to the plant is preferably carried out by spraying on the aerial parts of the plant, in particular on the aerial parts of the plant where the pistils are located (i.e. on the floral organs).

The acid whey can be applied to the plant at the time when desired to stimulate the germination of the pollen grain of said plant and/or the elongation of the pollen tube of said pollen grain. In particular, the acid whey can be applied to the plant at the time of flowering of the plant, preferably at the time of pollination or the time of fertilisation of the plant. Advantageously, the acid whey is applied to the plant at the start of the flowering stage (namely at the time when the first flowers appear). In practice, the acid whey can be applied in open fields or orchards by spraying the acid whey in liquid form on the plants, in particular on the pistils of the flowers.

Several applications of the acid whey on the plant are possible. The acid whey can be applied 2 to 8 times on the plant. For example, a first application of the acid whey can be carried out on a plant, then a second application of acid whey can be carried out on this same plant several days, or even several weeks, after the first application, for example 1, 2, 3, 4, 5, 6, 7, 8, 9, 10, 11, 12, 13, 14, 15 days after the first application. For example, the acid whey can be applied 4 to 8 times over a total period of 1 to 3 weeks. Advantageously, the first spraying of acid whey is performed at the start of flowering, the second spraying of acid whey is carried out more than 15 days after the first spraying, and a third spraying is carried out at the end of flowering. The precise time of the applications will be chosen according to the flowering period of a determined plant.

In the context of the use or the method according to the invention, the acid whey can be incorporated in a composition. Such a composition is then in liquid form. For example, the acid whey is mixed with an aqueous solvent, such as water. The preparation of such a composition will be able to be performed using the general knowledge the person skilled in the art. The acid whey content of the composition can be between 0.5% and 25% by dry weight compared with the dry weight of the composition, preferably between 1% and 10%, more preferably between 1% and 5%, for example 1.5% by dry weight compared with the dry weight of the composition.

The acid whey can be applied to the plant in variable quantities according to the needs of the plant, for example in an amount ranging from 0.001 L/ha to 15 L/ha, preferably ranging from 0.01 to 10 L/ha, more preferably ranging from 0.01 to 1 L/ha, for example ranging from 0.01 L/ha to 0.1 L/ha, for example 0.03 L/ha.

The composition containing acid whey can be applied to the plant in variable quantities according to the needs of the plant, for example in an amount ranging from 0.1 to 15 L/ha, more preferably ranging from 1 to 10 L/ha, still more preferably ranging from 1 to 5 L/ha, for example 2 L/ha.

The present invention has application in the treatment of a very large variety of plants, preferably flowering plants, such as those chosen from angiosperms and gymnosperms, in particular leguminous plants, cereal plants, fruit trees and oleaginous plants. Preferably, the flowering plants are chosen from (i) dicotyledons such as Solanaceae (e.g. tobacco, tomatoes, potatoes, aubergines), Chenopodiaceae (e.g. sugar beets), Fabaceae (e.g. soya, peas, alfalfa), Cucurbitaceae (e.g. melon, watermelon, cucumber, squash) Cruciferae or Brassicaceae (e.g. rapeseed, mustard), composites (e.g. chicory), Umbelliferae (e.g. carrots, cumin), Malvaceae (e.g. cotton, cacao, okra), Lamiaceae (lavender) and Rosaceae; (ii) Monocotyledons such as, for example, cereals (e.g. wheat, barley, oats, rice, maize) and Liliaceae (e.g. onion, garlic), and (iii) stone fruit trees and/or pome fruit trees (apple, cherry, plum, pear, apricot and peach trees, and kiwis). More preferably, the flowering plants are chosen from the tomato and the vine.

In an embodiment of the invention, the acid whey can be applied in combination with sucrose and/or in combination with a brown seaweed extract. Preferably, the acid whey can be applied in combination with an extract of Ascophyllum nodosum. More preferably, the acid whey can be applied in combination with sucrose and an extract of Ascophyllum nodosum. The brown seaweed extract and/or sucrose are also applied in liquid form. For example, sucrose can be applied to the plant before, after or at the same time as the application of the acid whey, preferably at the same time as the application of acid whey. The brown seaweed extract can be applied to the plant before, after or at the same time as the application of acid whey, preferably at the same time as the application of acid whey. For example, brown seaweed extract and/or sucrose can be applied to the plant 1, 2, 3, 4, 5, 6, 7, 8, 9, 10, 11, 12, 13, 14, 15 days, before or after the application of the acid whey. For example, the acid whey is applied to the plant at the same time as sucrose, then brown seaweed extract is applied to the plant, for example several days after. Advantageously, the acid whey, sucrose and brown seaweed extract are applied at the same time to the plant.

When the acid whey is applied in combination with sucrose and/or a brown seaweed extract, the sucrose and/or brown seaweed extract are preferably also applied to the plant at the time of flowering of the plant, preferably at the time of pollination or fertilisation. When the acid whey is applied in combination with sucrose and/or a brown seaweed extract, the sucrose and/or brown seaweed extract are preferably also applied by spraying, in particular on the aerial parts of the plant where the pistils are located.

When the acid whey is applied at the same time as sucrose and/or brown seaweed extract, they can be incorporated directly in the same composition. Such a composition is described in the section entitled “composition according to the invention”.

The brown seaweed extract can be applied to the plant in variable quantities according to the needs of the plant, for example in an amount ranging from 0.001 L/ha to 15 L/ha, preferably ranging from 0.01 to 10 L/ha, more preferably ranging from 0.01 to 1 L/ha, for example ranging from 0.01 L/ha to 0.05 L/ha, for example 0.02 L/ha or 0.03 L/ha.

Sucrose can be applied to the plant in variable quantities according to the needs of the plant, for example in an amount ranging from 0.001 L/ha to 15 L/ha, preferably ranging from 0.01 to 10 L/ha, more preferably ranging from 0.01 to 1 L/ha, for example ranging from 0.01 L/ha to 0.1 L/ha, for example 0.02 L/ha.

### Composition According to the Invention

According to a third aspect, the invention relates to a composition comprising (i) an acid whey and (ii) a brown seaweed extract.

Preferably, the composition according to the invention comprises (i) an acid whey and (ii) an extract of Ascophyllum nosodum.

The composition according to the invention can also comprise (iii) sucrose. Advantageously, the composition according to the invention comprises (i) an acid whey, (ii) an extract of Ascophyllum nosodum and (iii) sucrose.

The acid whey content of the composition according to the invention can be between 0.5% and 25% by dry weight compared with the dry weight of the composition, preferably between 1% and 10% by dry weight, more preferably between 1% and 5% by dry weight, for example 1.5% by dry weight compared with the dry weight of the composition.

The brown seaweed extract content of the composition according to the invention can

be between 0.5% and 25% by dry weight compared with the dry weight of the composition, preferably between 1% and 10% by dry weight, more preferably between 0.5% and 5%, for example between 0.5% and 2% by dry weight, for example between 1% and 1.5% by dry weight compared with the dry weight of the composition.

The sucrose content of the composition according to the invention can be between 0.5% and 25% by dry weight compared with the dry weight of the composition, preferably between 1% and 10% by dry weight, more preferably between 1 and 5% by dry weight, for example 1% by dry weight compared with the dry weight of the composition.

The dry-weight mass ratio between brown seaweed extract and acid whey can be between 0.02 and 50, preferably between 0.1 and 10, more preferably between 0.1 and 5, for example between 0.5 and 1.

The dry-weight mass ratio between sucrose and acid whey can be between 0.02 and 50, preferably between 0.1 and 10, more preferably between 0.2 and 5, for example between 0.6 and 0.7.

An example of a composition according to the invention comprises:
between 0.5% and 25%, for example 1.5%, by dry weight acid whey compared with the dry weight of the composition,
between 0.5% and 25%, for example between 1 and 1.5%, by dry weight brown seaweed extract compared with the dry weight of the composition, and
between 0.5% and 25%, for example 1%, by dry weight sucrose compared with the dry weight of the composition.

A particular example of a composition according to the invention comprises:
1.5% by dry weight acid whey, compared with the total weight of the composition,
1% by dry weight sucrose, compared with the total weight of the composition,
1 to 1.5% by dry weight brown seaweed extract, compared with the dry weight of the composition.

The composition according to the invention can be in dry form (for example in powder form) or in liquid form. The composition is preferably in liquid form so that it can be applied directly to the plant when flowering. For example, the composition according to the invention is in powder form and is mixed with a solvent, such as water, before being applied on the plant when flowering. The preparation of such a composition can be performed using the general knowledge of a person skilled in the art, for example by mixing the powder with a solvent while stirring.

The composition according to the invention can be used for stimulating germination of a plant pollen grain and/or elongation of the pollen tube of said pollen grain. This makes it possible, in particular, to improve crop yields and to increase the number of seeds and fruits of a plant.

The composition according to the invention can also be used to implement a method that can stimulate germination of a plant pollen grain and/or stimulate elongation of the pollen tube of said pollen grain, in which said composition according to the invention is applied to the plant in an amount sufficient for stimulating germination of the pollen grain and/or for stimulating elongation of the pollen tube of said pollen grain, and in which the composition is in liquid form. The features of the use and method described in the section entitled “use and method” are applicable to use of the composition according to the invention or to the composition according to the invention for implementing the method.

In particular, the composition according to the invention comprises a sufficient amount of (i) acid whey, (ii) brown seaweed extract and, optionally (iii) sucrose, in order to have an effect on the stimulation of germination of the pollen grain and/or elongation of the pollen tube of said pollen grain.

The composition according to the invention can be applied to the plant in variable quantities according to the needs of the treated plant, for example in an amount ranging from 0.1 to 15 L/ha, more preferably ranging from 1 to 10 L/ha, more preferably ranging from 1 to 5 L/ha, for example 2 L/ha.

The composition according to the invention can also comprise (iv) a fertilising product, preferably a fertiliser. Such compositions can best respond to the growth needs of the plant which are expressed, in particular, in terms of improving the development of the plant and the yield. The composition can comprise one or more fertilising products.

Examples of fertilisers that can be used in the composition, include liquid fertilisers and water-soluble fertilisers.

The fertilisers can be one or more substances chosen from urea, ammonium sulfate, ammonium nitrate, phosphate, phosphate salts, potassium chloride, magnesium nitrate, manganese nitrate, zinc nitrate, copper nitrate, phosphoric acid, potassium nitrate, potassium sulfate, calcium sulfate, calcium chloride and boric acid.

### BRIEF DESCRIPTION OF THE DRAWINGS

FIG. 1 represents a diagram of the transformation of the raw milk into various by-products, including whey.

FIG. 2 represents the percentage of viable pollen tubes over time as a function of the treatments applied (LAA+sucrose solution or control solution). Panels A, B, and C show the percentage of viable pollen tubes over time as a function of the treatments applied (LAA+sucrose solution or control solution) at a temperature of 8° C., 13° C. and 22° C. respectively. Panels D, E, F, G, H, and I show images of the emergence of viable pollen tubes over time under the control condition (left hand column) and under the LAA+sucrose condition (right-hand column) at temperatures of 8° C., 13° C. and 22° C. respectively.

FIG. 3 represents the density and length of the pollen tubes in micrometres (μm) as a function of the treatments applied (LAA+sucrose solution or control solution) after 4 hours. Panels A, B, and C show the length of the pollen tube in micrometres (μm) as a function of the treatments applied (LAA+sucrose solution or control solution) at a temperature of 8° C., 13° C. and 22° C. respectively.

FIG. 4 represents the percentage of pollen tubes having 0 to 6 callose plugs as a function of the treatments applied (LAA+sucrose solution or control solution) at a temperature of 8°° C., 13° C. and 22° C. respectively. Panels A, B, and C show images of pollen grains and pollen tubes under control conditions at a temperature of 8° C., 13° C. and 22° C. respectively, and indicate the presence of callose plugs by an arrowhead. Panels D, E, and F 4F show images of pollen grains and pollen tubes under LAA+sucrose conditions at a temperature of 8° C., 13° C. and 22° C. respectively, and indicate the presence of callose plugs by an arrowhead.

FIG. 5 shows the relative expression of four CalS genes as a function of the treatments applied (LAA+sucrose solution or control solution) and at a temperature of 8° C., 13° C. and 22° C. respectively. The graph at top left shows the expression of the gene Solyc01g006370.3. The graph at the bottom left shows the expression of the gene Solyc01g73750.3. The graph at top right shows the expression of the gene Solyc11g005985.1. The graph at bottom right shows the expression of the gene Solyc11g005980.2.

FIG. 6 represents the percentage of fruit setting (i.e the number of fruits formed) in apricot trees having been treated by leaf spraying with a treatment based on LAA+sucrose solution or a water-based control solution.

FIG. 7 represents the average weight of apricots at harvest, from apricots trees having been treated by leaf spraying with the treatment based on LAA+sucrose solution or a water-based control solution.

FIG. 8 represents the yield of apricots at harvest, from apricots trees having been treated by leaf spraying with the treatment based on an LAA+sucrose solution or a water-based control treatment

FIG. 9 represents the number of clusters of vines on vines having been treated by leaf spraying with a treatment based on LAA+sucrose solution or a water based control solution.

FIG. 10 represents the yield of berries at harvest, on vines having being treated by leaf spraying with the treatment based on LAA+sucrose solution or a water-based control solution.

FIG. 11 represents the number of fruit obtained per parcel, at harvest from pear trees having been treated by leaf spraying with the treatment based on an LAA+sucrose solution, a treatment based on a solution of LAA+sucrose+extract of the seaweed Ascophyllum nodosum, or a water-based control treatment.

FIG. 12 represents the average weight of fruits at harvest from pear trees having been treated by leaf spraying with a treatment based on an LAA+sucrose solution, a treatment based on a solution of LAA+sucrose+extract of the seaweed Ascophyllum nodosum, or a water-based control treatment.

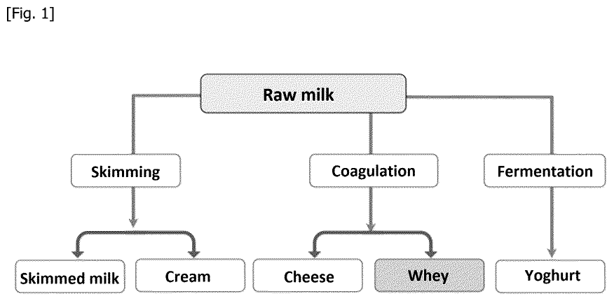

### EXAMPLES

### Example 1: Preparation of an Extract of Brown Seaweed of Type Ascophyllum nodosum

### Method

An extract of Ascophyllum nodosum was prepared according to the following method:

### Step 1: Washing

Fresh seaweed of type Ascophyllum nodosum underwent two successive washings in order to remove the sand and gravel.

### Step 2: Drying

The seaweed thus washed was drained and then dried, either in an air exchange oven or in a tunnel oven, in order to obtain a humidity level of approximately 10%.

### Step 3: Grinding

The dried seaweed was then ground into a powder of particle size between 250 and 600 μm.

### Step 4: Extraction

100 kg of dried and ground seaweed was dispersed in a heating reactor containing 900 kg of acidified water at pH 2.5 and heated beforehand to 45° C. The assembly was held under stirring for 3 hours.

### Step 5: Separation

Seaweed fragments were removed from the soluble extract by centrifugation or by decanting/filtering on a diatomaceous earth filter or a tray filter.

### Step 6. Storage

In order to bacteriologically stabilise the extract, 0.1% of sodium benzoate and 0.1% of potassium sorbate was added under stirring, and the pH of the extract was increased to 3.5 using a 30% NaOH solution.

The concentrated liquid extract thus obtained comprises between 3.5 and 5% by weight of dry extract (i.e. 35 to 50 g dry matter per litre of concentrated extract). The concentrated extract thus obtained corresponds to the extract used in the examples hereafter.

### Example 2: Preparation of a Composition According to the Invention Comprising Acid Whey and a Brown Seaweed Extract of Type Ascophyllum nodosum

15 grams of powdered acid whey were dissolved in 100 ml of water in order to obtain a concentrated solution of acid whey at 15% by dry weight.

10 grams of sucrose (in powder form and solid) were dissolved in 100 ml of water in order to obtain a concentrated solution of sucrose at 10% by dry weight.

300 mL of a concentrated brown seaweed extract of type Ascophyllum nodosum(comprising 3.5 to 5% by dry weight of an extract) obtained in Example 1 were mixed into 100 ml of acid whey solution and into 100 ml of sucrose solution. Water was added in order to obtain a final composition with a total volume of 1 litre. The final concentration of acid whey was 1.5%, the final concentration of sucrose was 1% and the final concentration of dried seaweed extract was between 1 and 1.5%.

TABLE 1

| | Quantity | |
|---|---|---|
| | by dry | Quantity |
| Composition in liquid form | weight (%) | in L |
| Brown seaweed extract of | 1 to 1.5% | 300 mL |
| type Ascophyllum Nodosum | | |
| (concentrated extract | | |
| comprising 3.5 to 5% dry | | |
| matter) | | |
| Acid whey (solution with 15% | 1.5% | 100 mL |
| dry weight of acid whey) | | |
| Sucrose (solution with 10% | 1% | 100 mL |
| dry weight of sucrose) | | |
| Water | q.s.f. | 500 mL |

### Example 3: Effect of a Solution Comprising Acid Whey on the Germination and Elongation of Pollen Grains From Solanum lycopersicum

### Materials and Method

Tomato plants of the type Solanum lycopersicum (seed variety of cherry tomato ‘West Virginia 106’) were sown 1 cm below the surface of the sterilised soil and cultivated in a growth chamber. The plants were cultivated under optimum conditions with cycles having 16 hours of light at a temperature of 25° C. and 8 hours of darkness at a temperature of 22° C. The relative humidity was maintained at 60%, and the plants were watered every 2 days. At flowering, the flowers were harvested in order to collect the pollen grains.

### Culture of the Pollen Grains and Pollen Tubes

Pollen grains were collected from the freshly dehisced anthers. The stamens of five flowers were immersed in 5 mL of BK medium BK [1.62 mM H₃BO₃, 1.25 mM Ca (NO₃)₂, 4H₂O, 2.97 mM KNO₃ and 1.65 mM MgSO₄, 7H₂O] containing 10% (w/v) sucrose (Brewbaker and Kwack, 1963). The pollen grains were suspended in BK medium by vortexing and the stamens were removed with tweezers. Tomato pollen tubes were cultivated on 24-well plates (from ThermoFisher), in darkness without stirring, at various temperatures: 8, 13, 22° C. The observations were carried out after 2, 4 and 6 hours growth. A pollen grain was considered to have germinated when the length of the pollen tube exceeded the diameter of the pollen grain.

### Method for Preparing an LAA+Sucrose Solution

15 g of powdered acid whey was mixed with 1 L of water in order to obtain a concentrated LAA solution with 1.5% by dry weight (i.e. 1.5 g for 100 mL). 10 g of sucrose were added to this solution (i.e. 1% by dry weight of sucrose added to the LAA solution, i.e. 1 g for 100 mL).

Method for Preparing a Solution Comprising an Extract of Ascophyllum nodosum

An aqueous solution was prepared having a concentration of 4% by dry weight of Ascophyllum nodosum extract.

### Treatments Applied

The following treatments were added to the culture medium of pollen grains and/or pollen tubes:
Treatment with a solution of acid whey and sucrose, called “LAA+sucrose” prepared according to the method described above. The LAA+sucrose solution was diluted with milli-Q water in order to attain a final acid whey concentration of 2 μg/mL of BK medium.
Treatment with a solution of Milli-Q water, used as negative control.
Treatment simultaneously combining a solution of acid whey+sucrose and a solution of Ascophyllum nodosum extract. The LAA+sucrose solution was diluted with milli-Q water in order to attain a final acid whey concentration of 2 g/mL of BK medium. The Ascophyllum nodosum extract solution was diluted with milli-Q water in order to attain a final concentration of Ascophyllum nodosum extract of 2 μg/mL of BK medium.

### Parameters Measured by Microscope

A Leica DMI 6000B inverted microscope equipped with the Leica DFC 450 camera was used to observe the development over time of the germination of pollen grains and elongation of the pollen tube. The deposition of callose plugs was observed under epifluorescence using a 405 nm absorption filter and a 523 nm emission filter. The ImageJ program [11] was used to measure the rate of germination of the pollen tube, the elongation of the pollen tube and the number of callose plugs.

### Statistical Analyses

The data correspond to the average of 6 biological replicates performed on different dates. Significant differences between the control and the treatment were determined by the single factor ANOVA method, followed by Dunnett's multiple comparison test. The data are marked with different letters when they differ with respect to the control conditions (value P<0.05). For germination, this represents between 1000 and 2000 pollen grains counted for each repetition and time point. For the length of the pollen tube, the number of measurements varied from 80 to 120 pollen tubes observed for each repetition.

### Measurement of the Number of Pollen Grain Germinations, the Length of the Pollen Tubes and Their Density

The number of pollen grains having germinated versus the number of non-germinated pollen grains or having a burst pollen tube was counted for the control, the treatment with LAA+sucrose solution, and the treatment with LAA+sucrose solution (final LAA concentration of 2 μg/mL) in combination with the solution comprising an Ascophyllum nodosum extract (final concentration of Ascophyllum nodosum extract of 2 μg/mL). The results are presented in table 2 below. An increase was observed in the number of pollen grains for which a “viable” pollen tube had emerged when the LAA+sucrose solution was applied in vitro on the pollen grains of tomatoes at temperatures of 8° C., 13° C. and 22° C. An increase was also observed in the number of pollen grains for which a “viable” pollen tube emerged when the LAA+sucrose solution was applied in combination with the solution comprising an extract of Ascophyllum nodosum, in particular with 52.99 pollen grains having a viable pollen tube with the combination LAA+sucrose+extract of Ascophyllum nodosum, 46.91 99 pollen grains having a viable pollen tube with the LAA+sucrose solution and 35.91 pollen grains having a viable pollen tube for the control. These results show the effect of the use of acid whey on the stimulation of the germination of the pollen grain, as well as the effect of the combination with sucrose and Ascophyllum nodosum extract.

TABLE 2

| | | | Number of | Number of |
|---|---|---|---|---|
| | | | pollen grains | pollen grains |
| | | Number of | for which a | for which a |
| Temperature | | non-germinated | “viable” pollen | “burst” pollen |
| in ° C. | Treatment applied | pollen grains | tube has emerged | tube has emerged |
| 8° C. | Control | 98.30 ± 0.57 | 0.52 ± 0.28 | 1.18 ± 0.36 |
| | LAA + sucrose | 94.08 ± 1.69* | 5.05 ± 1.71 | 0.86 ± 0.30 |
| | LAA + sucrose + Extract | 99.45 ± 0.30 | 0.55 ± 0.30 | 0.00 ± 0.00 |
| | of Ascophyllum nodosum | | | |
| 13° C. | Control | 61.87 ± 1.94 | 35.91 ± 1.82 | 2.22 ± 0.47 |
| | LAA + sucrose | 50.03 ± 1.85* | 46.91 ± 1.82* | 3.05 ± 0.59 |
| | LAA + sucrose + Extract | 45.60 ± 1.88* | 52.99 ± 1.72* | 1.41 ± 0.56 |
| | of Ascophyllum nodosum | | | |
| 22° C. | Control | 16.71 ± 2.00 | 66.95 ± 2.24 | 16.34 ± 1.48 |
| | LAA + sucrose | 15.55 ± 2.07 | 67.23 ± 1.94 | 17.22 ± 1.40 |
| | LAA + sucrose + Extract | 14.74 ± 3.71 | 71.42 ± 2.87 | 13.84 ± 1.78 |
| | of Ascophyllum nodosum | | | |

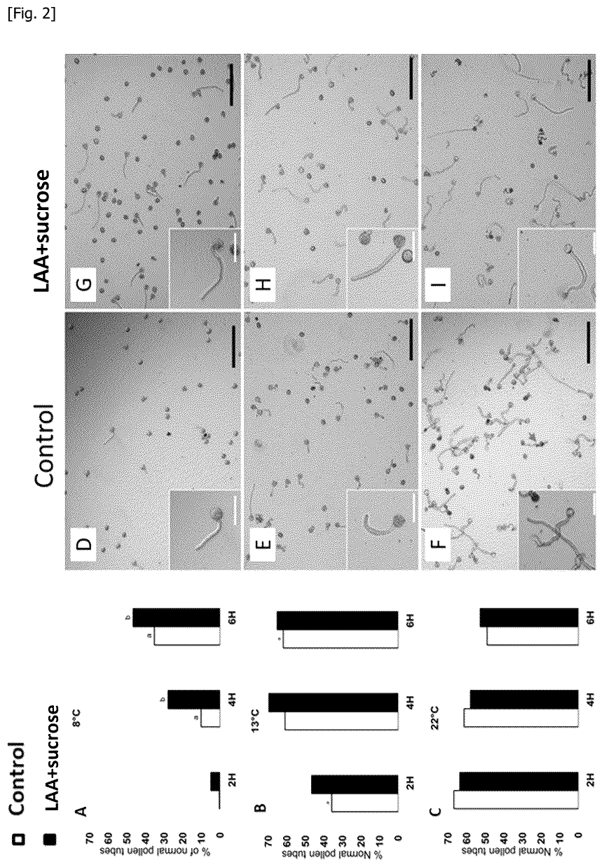

FIG. 2 shows the effect of the temperature and treatments on the morphology of the pollen tube and viability.

At the optimum temperature of 22° C. for the in vitro growth of tomato pollen tubes, the germination was rapid, with 67% of pollen grains germinated and viable pollen tubes after 2 hours culture for the control (FIG. 2, panels C and F), and 67% for the treatment with LAA+sucrose solution (FIG. 2, panels C and I).

The treatment with LAA+sucrose solution promoted the germination of the pollen at 8° C. with an increase in germination of pollen grains after 4 hours (FIG. 2, panels A, D, and G). After 6 hours, 48% of the pollen grains have germinated and the pollen tubes were morphologically normal after the application of the treatment LAA+sucrose compared with the control (36%) (FIG. 2, panels A, D, and G). When the germination of the pollen and the growth of the pollen tube was carried out at 13° C., the morphology and integrity of the pollen tube was also very well preserved (FIG. 2, panels B, E, and H). The treatment with LAA+sucrose solution had positive effects on the number of pollen tubes, at 2, 4 and 6 hours of culture (FIG. 2, panel B) at the temperature of 13° C. In particular, after 2 hours culture, the treatment with LAA+sucrose solution enabled the germination of 46% of the pollen grains.

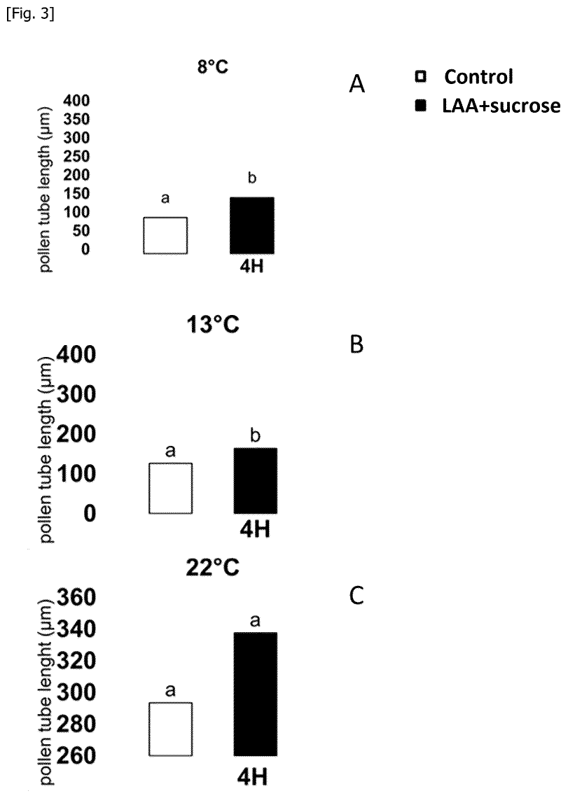

The graph of density of the length of pollen tubes after 4 hours at temperatures of 8, 13 and 22° C. (FIG. 3) shows the effect of the treatment with LAA+sucrose solution on the elongation of the pollen tube. More specifically, at a temperature of 8° C., the pollen tube has a length of 100 μm for the control, and 150 μm when they are treated with LAA+sucrose solution (FIG. 3, panel A). At a temperature of 13° C., the pollen tube has a length of 120 μm for the control, and was significantly higher when they are treated with LAA+sucrose solution with a length of 150 μm (FIG. 3, panel B). At a temperature of 22° C., the pollen tube has a length of 280 μm for the control, and was significantly higher when they are treated with LAA+sucrose solution with a length of 300 μm (FIG. 3, panel C).

The time necessary for attaining 50% of the germination rate (D value) was determined and the results are presented in table 3.

TABLE 3

| | D at | D at | D at |
|---|---|---|---|
| Treatment | 8° C. | 13° C. | 22° C. |
| Control | 4 hours | 1 hour | 0 hours |
| | 40 mins | 45 mins | 53 mins |
| LAA + sucrose | 3 hours | 1 hour | 0 hours |
| solution | 5 mins | 20 mins | 50 mins |

The treatment with LAA+sucrose solution has reduced the D values at the temperatures tested with a major effect at 8 and 13° C. More specifically, D_{8° C.} and D_{13° C.} with LAA+sucrose solution were 3 hours 5 minutes and 1 hour 20 minutes respectively (table 3).

### Determining the Number of Callose Plugs

### Cytochemical Staining of Callose Plugs

The pollen tubes were fixed after a culture time corresponding to 4 times the duration necessary for obtaining 50% of the highest germination rate of the control at each temperature tested (table 4). The fixing medium (100 mM PIPES, 4 mM MgSO₄, 7 H₂O, 4 mM EGTA, 10% (w/v) sucrose and 5% (v/v) paraformaldehyde at pH 7.5) was added to the BK medium and then incubated overnight at 4° C. with the pollen tubes. The pollen tubes were centrifuged at 4000 g for 7 minutes. The pellet was placed in suspension in 250 μl of fresh BK medium.

TABLE 4

| | 4*D at | 4*D at | 4*D at |
|---|---|---|---|
| Treatment | 8° C. | 13° C. | 22° C. |
| Control | 18 hours | 7 hours | 3 hours |
| | 40 mins | 00 min | 30 mins |
| LAA + sucrose | 12 hours | 5 hours | 3 hours |
| solution | 20 mins | 20 mins | 20 mins |

At temperatures of 22° C. and 13° C., 0.3% decolourised aniline blue (DAB) prepared in a 100 mM phosphate buffer at pH 12 (Johnson-Brousseau and McCormick, 2004) was added to the medium at a final concentration of 0.05%. At 8° C., a double staining with DAB and with calcofluor-white was used at final concentrations of 0.05% and 0.1%, respectively. The observations were carried out after 2 hours incubation in darkness at room temperature.

### Results

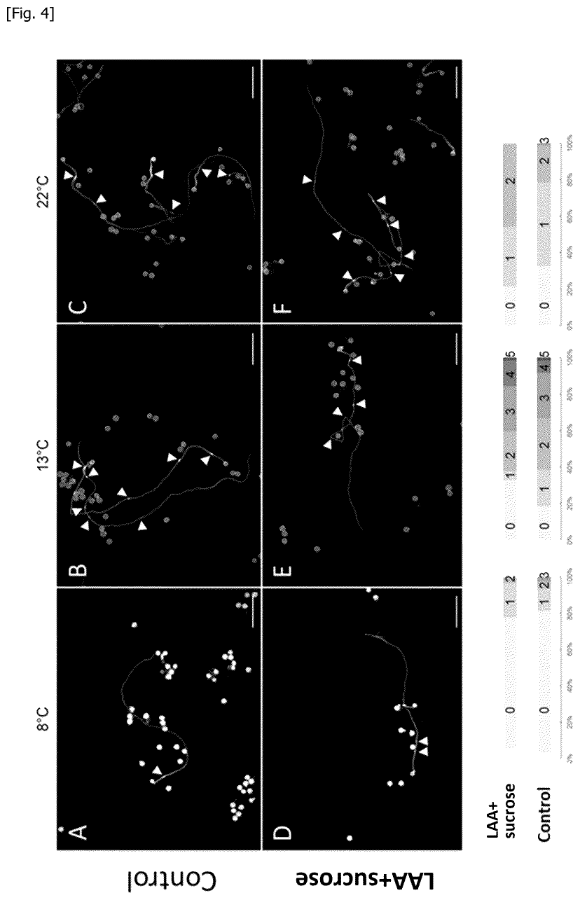

FIG. 4 shows the number of callose plugs formed as a function of the treatments applied. The number of callose plugs is higher during the treatment with LAA+sucrose solution. Under culture conditions at a temperature of 13° C. with treatment with LAA+sucrose solution, the percentage of pollen tubes having more than 3 callose plugs was 40% and the percentage of pollen tubes having more than 4 callose plugs was 18%. Under control conditions at a temperature of 13° C., the percentage of pollen tubes having more than 3 callose plugs was 35% and the percentage of pollen tubes having more than 4 callose plugs was 8%. Thus, the use of an LAA+sucrose solution on the pollens and pollen tubes has made it possible to increase the formation of callose plugs.

### Measuring the Expression of CalS Genes by qRT-PCR

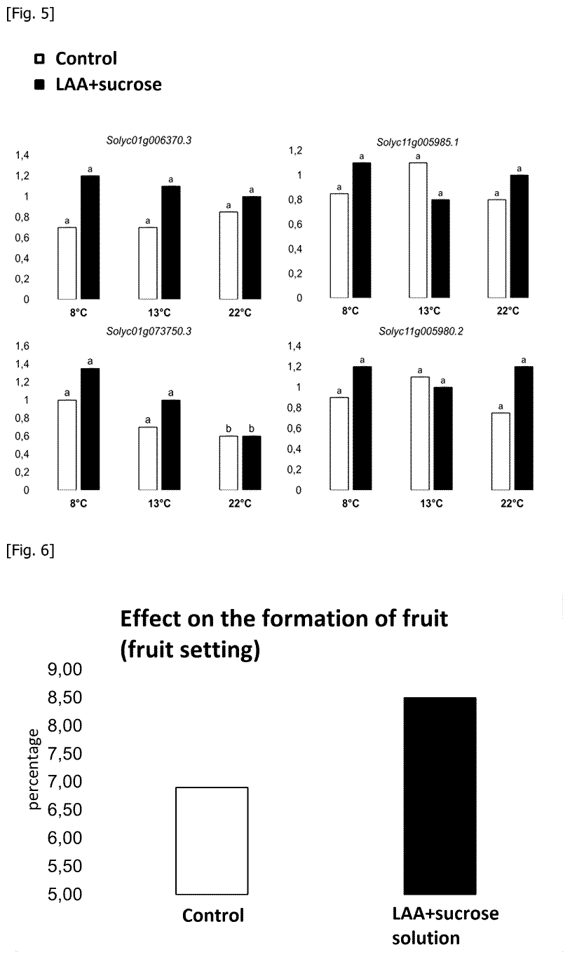

The genetic expression of four CalS gene sequences (FIG. 5) (Solyc01g73750.3, Solyc01g006370.3, Solyc11g005980 .2 and Solyc11g005985.1.) in the genome of the tomato was measured using TBLASTN analysis [12].

### RNA Extraction and Genetic Expression Analysis

RNA was extracted from the culture of pollen grains of two tomato flowers in 2 ml of BK germination medium for each treatment (control, LAA solution) at 8, 13 and 22° C. The samples were collected at D_{8° C.}, D_{13° C.} and D_{22° C.} (table 3). First, the BK germination medium was withdrawn from the pollen grain culture after centrifugation and replaced by 1 ml of NucleoZOL (Macherey-Nagel, Düren, Germany). The pollen tubes were then split by flux-reflux and vortexed. The extraction of the total RNA was carried out using the Nucleospin® RNA of the NucleoZOL kit following the manufacturer's protocol (Macherey-Nagel, Duren, Germany). The quality of the extracted RNA was verified in a 4200 Tapestation (Agilent Technologies, CA, USA), followed by a DNase treatment (Turbo DNA-free® kit) and the synthesis of cDNA from 1 μg of RNA, using the iScript™ gDNA Clear cDNA synthesis kit (Bio-Rad, CA, United States). The diluted samples of cDNA were used for studying gene expression by quantitative real-time PCR (CFX384 Touch™, Bio-Rad, CA, USA) in a total volume of 10 μl using the technology “SoAdvanced Universal SYBR Green Supermix” (Bio-Rad, CA, United States). All of the qPCR reactions were performed in triplicate using independent cDNA reactions for each of the six biological replicates and 300 nM of gene specific primer pairs. The thermal cycling protocol comprised a single activation step of the polymerase at 98° C. for 3 minutes followed by 40 amplification cycles, a final extension step at 72° C. for 5 minutes, also as melting curve analysis. Each amplification cycle comprised a denaturation step at 98° C. for 15 seconds, a step of annealing the primer for 30 seconds and a brief extension at 72° C. for 15 seconds. For each primer pair, the effectiveness of the pairs was determined by carrying out a standard curve analysis using series dilutions. The expression data were acquired and analysed using the CFX Maestro version 1.1 software (Bio-Rad, CA, USA). The specific primers for all the candidate and reference genes are listed in table 5.

TABLE 5

| Gene | Sequence ID | Primer |
|---|---|---|
| CalsS cDNA | Solyc11g005980.2 | Direct primer: |
| XM_019211256.2 | | CGTCGAGTCTTGCTTCTCGT (SEQ |
| | | ID NO: 1) |
| | | Indirect primer: |
| | | AGCTGAGCTCTGTCTGCTTG (SEQ |
| | | ID NO: 2) |
| CalsS cDNA | Solyc11g005985.1 | Direct primer: |
| XM_004228545.4 | | AGTGGGAAGAACAGCTTCGG |
| | | (SEQ ID NO: 3) |
| | | Inverse primer: |
| | | CTTCTCCGTGCTTCGAGGTT (SEQ |
| | | ID NO: 4) |
| CalsS cDNA | Solyc01g006370.3 | Direct primer: |
| XM_026029202.1 | | AAGTGATTGCACGGGAAGC (SEQ |
| | | ID NO: 5) |
| | | Inverse primer: |
| | | CTGAAGCAGTCCACTGACCA (SEQ |
| | | ID NO: 6) |
| CalsS cDNA | Solyc01g073750.3 | Direct primer: |
| XM_026031249.1 | | AGGAGGATTATGGAGTTGCTG |
| | | (SEQ ID NO: 7) |
| | | Inverse primer: |
| | | GCAACTTCCTCTTAACTTTACCAAA |
| | | (SEQ ID NO: 8) |

### Results

The effect of cold stresses is not accompanied by strong variations in the expression of CalS genes under the control condition. The results presented in FIG. 5 show a variation of the expression CalS genes compared with the control condition when the LAA+sucrose solution was applied, whatever the temperature. In particular, an increase is observed in the expression of the gene Solyc019006370.3. Thus, the use of the LAA+sucrose solution on the pollen grains and the pollen tubes has enabled an overall increase in the expression of the genes involved in the biosynthesis of callose at various external temperatures, in particular the genes coding for the callose synthase, CalS, and callose synthase-like, CalS like, enzymes.

### Example 4: Determining the Effects of the use of Acid Whey on Apricots Trees

### Experimental Protocol

The testing was carried out on a parcel of apricots trees planted in 2007 (Prunus armeniaca; variety Mele Cot). This testing demonstrated the effect of acid whey on the development of the fruit, in particular during fruit setting, the initial formation phase of the fruit. The yield of the harvest was measured.

Five trees of variety Mele Cot grafted on Mirabolan rootstock (a variety known to have a low rate of fruit formation after sexual reproduction in apricot trees) were used. For this test, two treatments based on leaf spraying were compared:
a treatment consisting of an LAA+sucrose solution: 15 g of acid whey in powdered form were dissolved in 1 L of water and mixed with 10 g of sucrose in powder form (i.e. a solution comprising 1.5% by dry weight acid whey and 1% by dry weight sucrose compared with the total weight of the solution). Three applications of the LAA+sucrose solution at a concentration of 2 L/ha were performed at phenolic stage BBCH 59, 64 and 69 of the trees.
a control treatment for which water was applied by leaf spraying at the same phenolic stages (namely BBCH 59, 64 and 69).

The apricots trees were treated with a usual phytosanitary treatment for avoiding the destruction of the harvest by parasites.

The apricots were then harvested at the BBCH99 stage.

### Results

The percentage of fruit setting (i.e the number of fruits formed) was calculated for each of the two treatments. The results obtained are presented in FIG. 6. The results show that when the LAA+sucrose solution was applied, the percentage of fruit setting determined at BBCH 73 has increased, going from 6.9% for the control condition to 8.5% for the LAA+sucrose solution.

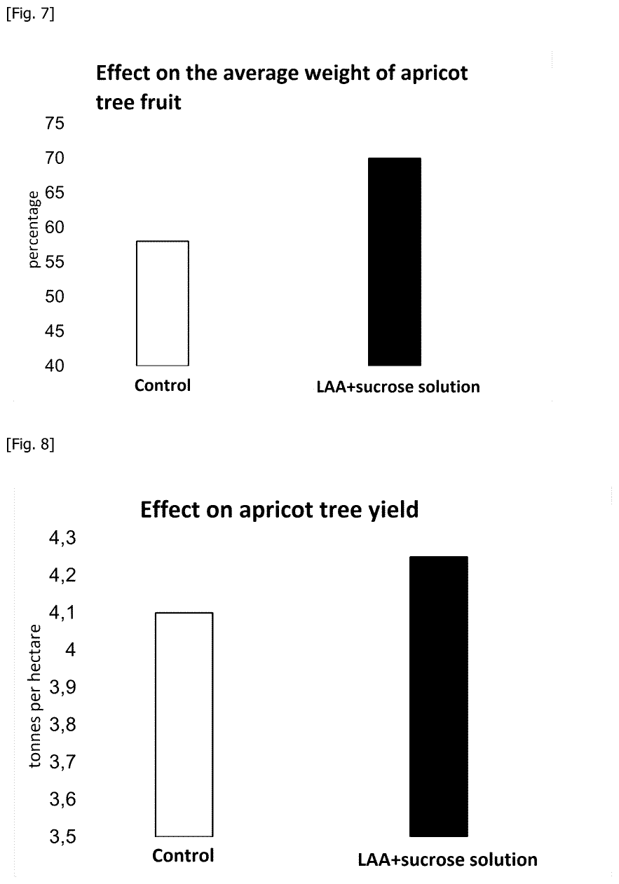

The average weight of the apricots at harvest was calculated for each of the two treatments. The results obtained are presented in FIG. 7. The results show that when the LAA+sucrose solution is applied, the average weight of the apricots at harvest determined at BBCH 99 has increased, going from 58 grams for the control condition to 70 gram for the LAA+sucrose solution.

Finally, the yield at the harvest was calculated for each of the two treatments. The results obtained are presented in FIG. 8. The results show that when the LAA+sucrose solution was applied, the yield at harvest determined at BBCH 99 has increased, going from 4.1 tonnes for the control condition to 4.25 tonnes for the LAA+sucrose solution.

### Example 5: Demonstrating the Effects of the use of Acid Whey on the Vine

### Experimental Protocol

The testing was carried out on a parcel of vines planted in 2003 (Vitis vinifera; variety Sugraone). This test aims to demonstrate the effect of acid whey in combination with an extract of Ascophyllum nodosum on the yield and quality of the grape berries at harvest.

For this test, two treatments based on leaf spraying were compared:
a treatment consisting of an LAA+sucrose solution: 15 g of acid whey in powdered form were dissolved in 1 L of water and mixed with 10 g of sucrose in powder form (i.e. a solution comprising 1.5% by dry weight acid whey and 1% by dry weight sucrose compared with the total weight of the solution). Three applications of the LAA+sucrose solution at a concentration of 2 L/ha were performed at phenolic stage BBCH 59, 64 and 69 of the individual vine plants.
a control treatment for which water was applied by leaf spraying to support flowering at phenolic stage BBCH 57, 65 and 69.

Seven individual vine plants were treated for each modality. The individual vine plants were treated with a usual phytosanitary treatment for avoiding the destruction of the harvest by parasites.

The grape clusters and berries were then harvested at stage 99.

### Results

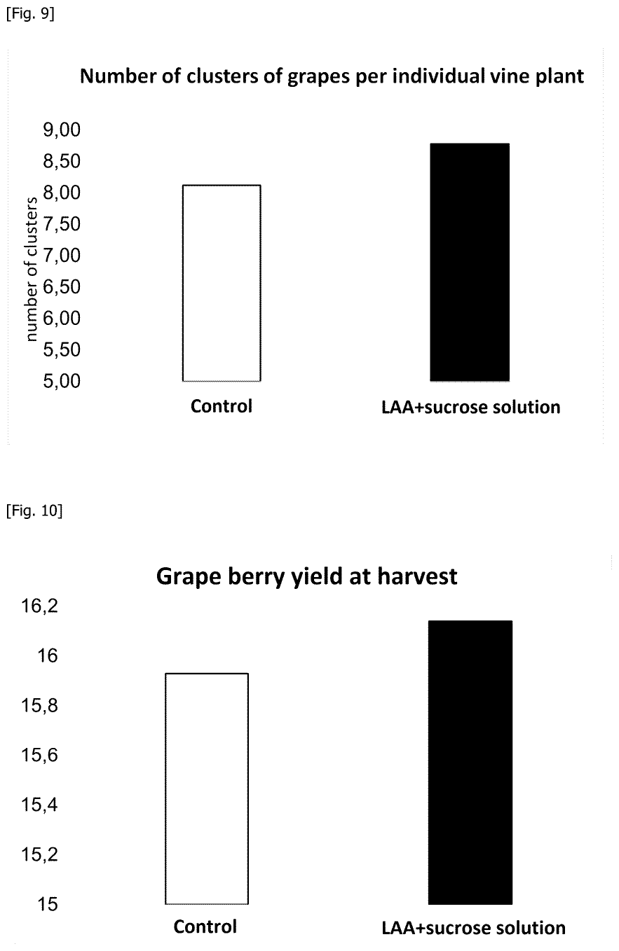

The number of clusters of grapes per individual vine plant, at harvest, was determined for each of the three programmes. The results obtained are presented in FIG. 9. They show that for the control, 8.12 clusters of grapes were counted on average per individual vine plant. When the LAA+sucrose solution was applied, the number of clusters of grapes counted was 8.78 per individual vine plant.

The yield of berries at harvest, was determined for each of the two programmes. The results obtained are presented in FIG. 10. They show that for the control, the yield of berries per parcel was 53.98 kg (i.e. 15.93 tonnes per hectare). When the LAA+sucrose solution was applied, the yield per parcel was 54.68 kg (i.e. 16.140 tonnes per hectare).

### Example 6: Demonstrating the use of Acid Whey in Combination With an Extract of Ascophyllum nodosum on Pear Trees

### Experimental Protocol

The testing was carried out on a parcel of pear trees planted in 2003 pear tree (Pyrus communis, variety Concorde). This test aimed to show the effect of acid whey in combination with an extract of Ascophyllum nodosum on the yield and quality of the pear.

Six trees of the Concorde variety were used. For this test, three treatments based on leaf spraying were compared:
a treatment consisting of an LAA+sucrose solution: 15 g of acid whey in powdered form were dissolved in 1 L of water and mixed with 10 g of sucrose in powder form (i.e. a solution comprising 1.5% by dry weight acid whey and 1% by dry weight sucrose compared with the total weight of the solution). Three applications of the LAA+sucrose solution at a concentration of 2 L/ha were performed at phenolic stage BBCH 59, 64 and 69 of the trees.
a treatment consisting of an LAA+sucrose+seaweed solution, which corresponds to the solution of Example 2, was applied. Three applications of the LAA+sucrose+seaweed solution (prepared according to Example 2) at a concentration of 2 L/ha were performed at phenolic stage BBCH 59, 64 and 69 of the trees.
a control treatment for which water was applied by leaf spraying to support flowering at phenolic stage BBCH 59, 64 and 69.

The pear trees were treated with a usual phytosanitary treatment for avoiding the destruction of the harvest by parasites.

The pears were then harvested at BBCH99.

### Results

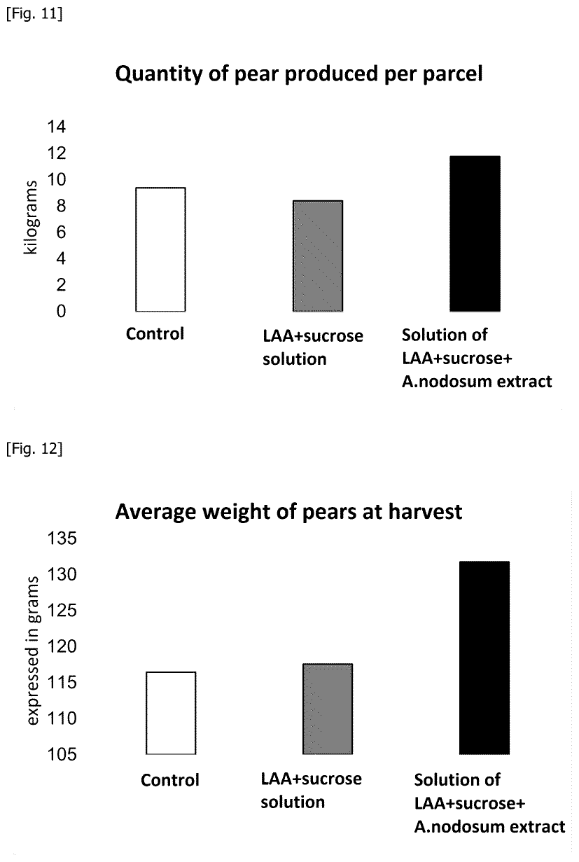

The number of fruit obtained per parcel, at harvest, was determined for each of the three treatments. The results obtained are presented in FIG. 11. They show that for the control, 10 kg of pears were produced per parcel, whereas when the LAA+sucrose solution was applied in combination with extract of Ascophyllum nodosum, 12 kg of pears were produced per parcel.

The average weight of the fruits at harvest was determined for each of the three treatments. The results obtained are presented in FIG. 12. They show that for the control condition, the average weight of a fruit was 116.47 grams. When the LAA+sucrose solution was applied, the average weight of a fruit was then 117.58 grams. Finally, when the extract of Ascophyllum nodosum was added with LAA+sucrose solution, the average weight of a fruit was 131.77 grams. This therefore clearly shows the synergistic effect of the combination of acid whey with an extract of Ascophyllum nodosum on the weight of the fruits at harvest.

### BIBLIOGRAPHY

1. Lamaoui et al., 2018
2. GIEC 2014, Hoegh-Guldberg et al., 2018
3. Zamir et al., 1981;
4. Kakani et al., 2002;
5. Boavida and McCormick, 2007
6. Prasad et al., 2006
7. Zamir et al., 1982
8. Clarke and Siddique, 2004
9. Porch and Jahn , 2001
10. Kakani et al., 2002
11. Abramoff et al., 2004
12. Altschul et al., 1997

1. (canceled)

2. A method for stimulating the germination of a plant pollen grain and/or for stimulating the elongation of the pollen tube of said pollen grain, in which an acid whey in liquid form is applied to the plant in an amount sufficient to stimulate the germination of the pollen grain and/or to stimulate the elongation of the pollen tube of said pollen grain.

3. The method according to claim 2, in which the plant is in a condition of thermal stress.

4. The method according to claim 2, in which the acid whey has a pH ranging from 2 to 5.5, preferably a pH ranging from 4 to 5.

5. The method according to claim 2, in which the acid whey is applied by spraying onto the plant.

6. The method according to claim 2, in which the acid whey is applied to the plant at the time of flowering of the plant.

7. The method according to claim 2, in which the acid whey increases the speed of elongation of the pollen tube by at least 5%, advantageously by at least 10%, at least 15%, at least 20%, at least 25%, at least 30%, at least 40%, at least 50% compared with a pollen grain that is not treated with acid whey.

8. The use method according to claim 2, in which the acid whey is applied in combination with sucrose.

9. The method according to claim 2, in which the acid whey is applied in combination with a brown seaweed extract, preferably an extract of Ascophyllum nodosum.

10. A composition comprising (i) an acid whey and (ii) a brown seaweed extract.

11. The composition according to claim 10, further comprising (iii) sucrose.

12. The composition according to claim 10, in which (ii) the brown seaweed extract is chosen from an extract of Ascophyllum nodosum, an extract of Fucus serratus, an extract of Fucus vesiculosus, an extract of Laminaria hyperborea, an extract of Laminaria saccharina, an extract of Laminaria digitata, an extract of Laminaria japonica, an extract of Ecklonia maxima, an extract of Macrocystis pyrifera, an extract of Himanthalia elongata or an extract of Sargassum spp, preferably an extract of Ascophyllum nodosum.

13. The composition according to claim 10, in which
the content of acid whey is between 0.5% and 25% by dry weight compared with the dry weight of the composition, preferably between 1% and 10%, more preferably between 1% and 5%, for example 1.5%,
the content of brown seaweed extract is between 0.5% and 25% by dry weight compared with the dry weight of the composition, preferably between 1% and 10%, more preferably between 0.5 and 5%, for example between 0.5% and 2%, for example between 1% and 1.5%, and/or
the content of sucrose is between 0.5% and 25% by dry weight compared with the dry weight of the composition, preferably between 1% and 10%, more preferably between 1 and 5%, for example 1%.

14. A method for stimulating the germination of a plant pollen grain and/or for stimulating the elongation of the pollen tube of said pollen grain, in which the composition according to claim 10 is applied in liquid form to the plant in an amount sufficient for stimulating the germination of the pollen grain and/or for stimulating the elongation of the pollen tube of the pollen grain.
